(19) United States
(12) Patent Application Publication
(10) Pub. No.: US 2026/0194415 A1
(43) Pub. Date: Jul. 9, 2026

(54) METHOD FOR INSTALLING FLANGE CONNECTIONS, USE OF A BOLT TENSIONING DEVICE, COMPUTER PROGRAM PRODUCT, USE OF A COMPUTER PROGRAM PRODUCT AND STORAGE MEDIUM

(71) Applicant: SCHAAF GmbH & Co. KG, Erkelenz (DE)

(72) Inventors: Ralf KÖLLGES, Erkelenz (DE); Falk LÜDDECKE, Hamburg (DE); Filip WEGENER, Hamburg (DE)

(73) Assignee: SCHAAF GmbH & Co. KG, Erkelenz (DE)

(21) Appl. No.: 19/552,848

(22) Filed: Feb. 27, 2026

Related U.S. Application Data
(63) Continuation of application No. PCT/EP2024/073995, filed on Aug. 28, 2024.

(30) Foreign Application Priority Data
Aug. 29, 2023 (DE) 1020231231693

(51) Int. Cl. G01M 5/00; B23P 19/06; G01L 5/24

(52) U.S. Cl. CPC G01M 5/00; B23P 19/067; G01L 5/24

(57) ABSTRACT

A method that includes determining flange parameters of a first flange and a second flange, determining a bolt system-typical elongation behavior, determining an axial stiffness for at least one bolt and determining an axial stiffness of a flange body formed by applying an installation pre-tensioning force to the bolt to mechanically connect the first flange and the second flange to each other. The method further includes analyzing the flange body for maximally permissible gap dimensions, determining an overall stiffness of the flange body, introducing a bolt system into a corresponding first flange recess and a corresponding second flange recess that are aligned with each other, determining a reached overall stiffness of the flange body, comparing the reached overall stiffness to the overall stiffness, and tightening the nut of the bolt system with an installation tensioning force when the reached overall stiffness is larger than or equal to the overall stiffness.

### CROSS-REFERENCE TO RELATED APPLICATIONS

This application is a Bypass Continuation of International Application No. PCT/EP2024/073995, filed on Aug. 28, 2024, which claims priority to and the benefit of DE 10 2023 123 169. 3 filed on Aug. 29, 2023. The disclosures of the above applications are incorporated herein by reference.

### FIELD

The present disclosure relates to a method for installing flange connections, a use of a bolt tensioning device, a computer program product and a storage medium.

### BACKGROUND

The statements in this section merely provide background information related to the present disclosure and may not constitute prior art.

In the field of flange connections, in particular those, which are used in wind energy plants or comparable structures, there is a constant need for improvements with regard to the reliability, efficiency and safety of the installation processes. EP 3 593 939 A1 discloses a method and a device for installing flange connections. Even though this method is reliable and efficient in many applications, there are still challenges with regard to certain aspects, for example a control of fatigue impairments, a precise alignment and installation of the flange connections and a handling of variable gap dimensions between the flanges.

CN 217980767 U discloses a fastening test device for testing the fastening durability of a screw. CN 108875176 B discloses an active design method for a shape of an installation adhesive surface. Wegener Filip ET AL: “Numerical Simulation of Pre-tensioning Force Losses in Ring Flange Connections”, Der Stahlbau, Vol. 89, No. 12, Sep. 15, 2020 (2020 Sep. 15), discloses whether pre-tensioning force losses are to be expected in flange connections and by means of which influencing factors they are largely determined. US 2014/350724 A1 discloses a robot for bolting a number of screw nuts in a common round flange connection of a wind power plant. LIU XUE-CHUN ET AL: “Tension-bend-shear capacity of bolted-flange connection for square steel tube column”, ENGINEERING STRUCTURES, ELSEVIER, AMSTERDAM, NL, Vol. 201, Oct. 19, 2019, discloses a study in which square steel tube columns are connected by means of bolted flanges instead of the traditional welding.

### SUMMARY

This section provides a general summary of the disclosure and is not a comprehensive disclosure of its full scope or all of its features.

In light of the foregoing, the present disclosure provides an improved method for installing flange connections. The method is to in particular be able to effectively handle variable gap dimensions. It should furthermore be possible to reduce the risk of fatigue impairment and to enhance the installation process.

Further areas of applicability will become apparent from the description provided herein. It should be understood that the description and specific examples are intended for purposes of illustration only and are not intended to limit the scope of the present disclosure.

### DRAWINGS

The present disclosure does not include any drawings.

### DETAILED DESCRIPTION

The following description is merely exemplary in nature and is not intended to limit the present disclosure, application, or uses. It should be understood that throughout the drawings, corresponding reference numerals indicate like or corresponding parts and features.

According to one form, the present disclosure provides a method for installing flange connections. The flange connection has at least one first flange, a second flange and a number of bolt systems. The first and the second flange each has a plurality of flange recesses. The flange recesses of the first flange can be aligned to the flange recesses of the second flange. The bolt systems each have at least one bolt, a nut and an abutment. The method comprises the steps of: a) determining flange parameters at least of the first flange and of the second flange of the flange connection, b) analytically determining a bolt system-typical elongation behavior, determining a bolt system-typical stiffness C_{bolt} and determining an axial stiffness of the flange body of the pre-tensioned flange connection, c) analytical and/or numerical analysis for specifying the maximally permissible gap dimensions Sₙ, so that a fatigue impairment to the bolt system in consideration of a specific boundary condition does not exceed a defined total impairment, analytically determining an overall stiffness C_{target}, which is to be reached, of the tensioned flange body in consideration of the previously determined maximally permissible gap dimensions Sₙ and of the installation pre-tensioning force Fₘ, which must be reached for a fatigue safety of the connection during the pre-tensioning, introducing the bolt systems into the flange recesses, which are aligned to one another of the first flange and of the second flange, installing the bolt tensioning device on a bolt, applying an installation pre-tensioning force Fₘ to the bolt and determining a reached overall stiffness C_{act} of the tensioned flange, comparing the reached overall stiffness C_{act} to the overall stiffness C_{target}, which is to be reached, and tightening the nut of the bolt system with an installation tensioning force F_{target} when the value of the reached overall stiffness C_{act} in relation to the applied installation pre-tensioning force Fₘ is larger than or equal to the overall stiffness C_{target}, which is to be reached, in relation to the applied installation pre-tensioning force Fₘ.

According to the another form, the present disclosure provides a use of a bolt tensioning device comprising a housing, a tensioning unit, a distance measuring device, a tensioning determination and a computing unit. A reached overall stiffness C_{act} can be measured by the distance measuring device. A numerically and/or analytically determined overall stiffness C_{target}, which is to be reached, can be stored by the computing unit, for carrying out an above-mentioned method.

According to yet another form, the present disclosure provides a computer program product comprising commands, which have the effect that a bolt tensioning device carries out the method according to the present disclosure, with a data set comprising at least one reference value series, which is determined from the steps of a) determining flange parameters at least of the first flange and of the second flange of the flange connection, b) analytically determining a bolt system-typical elongation behavior, determining an axial stiffness C_{bolt} for the bolt and determining an axial stiffness of the flange body of the pre-tensioned flange connection, c) analytical and/or numerical analysis for specifying the maximally permissible gap dimensions Sₙ, so that a fatigue impairment to the bolt system in consideration of a specific boundary condition does not exceed a defined total impairment, and d) analytically determining an overall stiffness C_{target}, which is to be reached, of the tensioned flange body in consideration of the previously determined maximally permissible gap dimensions Sₙ and of the installation pre-tensioning force Fₘ, which must be reached for a fatigue safety of the connection during the pre-tensioning.

The reference value series, which in each case reflects a target value of a relation of a numerically and/or analytically determined overall stiffness C_{target}, which is to be reached, to an installation pre-tensioning force Fₘ. A reached overall stiffness C_{act} in relation to an applied installation pre-tensioning force Fₘ on a bolt system can be compared to the target value, so that a qualitative statement about the flange connection at a position of a bolt system can be output by the computer program product. Depending on the qualitative statement, the computer program prompts a nut of the bolt system to be tightened or the bolt system to be released.

According to one form, the present disclosure provides a use of a computer program product according to the above-mentioned use or the above-mentioned method.

According to another form, the present disclosure provides a storage medium on which the computer program is stored. The storage medium comprises a data set comprising at least one reference value series, which in each case reflects a relation of a numerically and/or analytically determined target value of an overall stiffness C_{target}, which is to be reached, to an installation pre-tensioning force Fₘ. The reference value series is determined from the steps of determining flange parameters at least of the first flange and of the second flange of the flange connection, analytically determining a bolt system-typical elongation behavior, determining an axial stiffness C_{bolt} for the bolt and determining an axial stiffness of the flange body of the pre-tensioned flange connection, analytical and/or numerical analysis for specifying the maximally permissible gap dimensions Sₙ, so that a fatigue impairment to the bolt system in consideration of a specific boundary condition does not exceed a defined total impairment, analytically determining an overall stiffness C_{target}, which is to be reached, of the tensioned flange body in consideration of the previously determined maximally permissible gap dimensions Sₙ and of the installation pre-tensioning force Fₘ, which must be reached for a fatigue safety of the connection during the pre-tensioning.

The present disclosure provides a method for installing flange connections. The flange connection has at least a first flange, a second flange and a number of bolt systems. The first and the second flange each has a plurality of flange recesses. The flange recesses of the first flange can be aligned to the flange recesses of the second flange. The bolt systems each have at least one bolt, a nut and an abutment, comprising the steps of: determining flange parameters at least of the first flange and of the second flange of the flange connection, analytically determining a bolt system-typical elongation behavior, determining a bolt system-typical stiffness C_{bolt} and determining an axial stiffness of the flange body of the pre-tensioned flange connection, analytical and/or numerical analysis for specifying the maximally permissible gap dimensions Sₙ, so that a fatigue impairment to the bolt system in consideration of a specific boundary condition does not exceed a defined total impairment, analytically determining an overall stiffness C_{target}, which is to be reached, of the tensioned flange body in consideration of the previously determined maximally permissible gap dimensions Sₙ and of the installation pre-tensioning force Fₘ, which must be reached for a fatigue safety of the connection during the pre-tensioning, introducing the bolt systems into the flange recesses, which are aligned to one another, of the first flange and of the second flange, installing the bolt tensioning device on a bolt, applying an installation pre-tensioning force Fₘ to the bolt and determining a reached overall stiffness C_{act} of the tensioned flange, and comparing the reached overall stiffness C_{act} to the overall stiffness C_{target}, which is to be reached.

The method of the present disclosure can in particular be used for installing flange connections, in particular those, which are used in wind energy plants or similar structures. The flange connection is at least one first flange and a second flange. This setup provides for a systematic and precise installation, which increases the reliability and stability of the connection.

Flange connections are important in modern wind power plants, which represent a key technology for producing renewable energies. Such connections, consisting of at least one first and a second flange, can often be found at various points of the plant, such as, for instance, at the connection between the tower and the hub or between individual tower segments. The mechanical integrity of these connections is crucial because they must withstand the dynamic and static loads, which are created by the operation of the wind power plant. These loads vary depending on wind speed, wind direction and further environmental factors.

The adaptation to these variable stresses is a challenge when designing flange connections in wind power plants. The connection is exposed to constantly changing forces during the operating time of the plant, which leads to cyclical stress and potential signs of fatigue. Factors, such as corrosion, in particular in offshore applications, or temperature fluctuations can furthermore negatively impact the integrity of the flange connection. A proper installation, screw connection and sealing of the flanges are thus desirable in order to avoid leaks, premature wear or even impairment.

In addition, the challenge is that each flange connection is unique due to production deviations, even if it is manufactured according to standardized designs. One aspect are gaps between the flanges, which are to be connected to one another. These gap dimensions can be influenced by different factors, such as, for instance, manufacturing tolerances, uneven load distribution, settlement processes or thermal expansion.

An unwanted or uncontrolled gap dimension can lead to a plurality of challenges. On the one hand, an excessive gap can negatively impact the sealing effect between the flanges, which can lead to leaks and subsequently to corrosion processes, especially in maritime environments, in which wind power plants are often exposed to salty air. A gap, which is not desirable, can in particular negatively impact the load transmission and thus the overall stability of the connection. This can become crucial in particular in the case of the dynamic and cyclical loads, to which wind power plants are exposed.

In addition to the mechanical integrity, an excessive gap dimension can also cause vibration. Vibrations can propagate over the tower and can negatively influence the service life of the plant as well as the efficiency thereof.

It is furthermore important to note that an uncontrolled gap may be undesirable for the bolt system. A gap can lead to uneven load distribution to the bolts, which, in turn, increases the risk of fatigue fractures.

For all these reasons, it is desirable to precisely define, monitor and optionally adapt the gap dimensions between the flanges during the construction as well as during the operation of wind power plants.

The efficient and secure connection of at least two flanges in wind power plants is desirable. The draft and the implementation of such connections desire an understanding of the underlying mechanical principles as well as of the specific demands and challenges, which appear in the context of wind power plants.

The first and second flange each have flange recesses, which can be aligned to one another. Bolt systems are introduced into these recesses, which are aligned to one another. A bolt system in each case comprises at least one bolt, in one form, a threaded bolt, a nut and an abutment. The abutment can be configured, for example, as screw head or counter nut. The bolt systems can also have at least one washer, which can, in one form, be arranged below the nut and/or the abutment. In one configuration, it is provided that the nut and/or the counter nut has a nut internal thread, which corresponds to the external thread of a pre-tensioned bolt. In one example, a support surface of the nut is configured in such a way that no washer needs to be used therewith. The nut, in one form, has a flat support surface, which is may be formed at a right angle to a thread axis of the nut. If the abutment is configured as counter nut, the above statements with regard to the nut likewise apply for the counter nut of the abutment. The bolt is, in one form, a threaded bolt. The external thread of which corresponds to the internal thread of the nut and optionally of the counter nut or the geometry of the external thread of which corresponds to the nut internal thread and optionally the counter nut internal thread, in one form, when applying a maximum force to the bolt. In one form, the screw connection or the bolt system, respectively, is an HV screw set.

A threaded bolt, which comprises two nuts, is an example of a bolt system. A threaded bolt, which comprises two nuts and two washers, is a further example of a bolt system. A threaded screw, which comprises a nut, is a further example of a bolt system. A threaded screw, which comprises a nut and two washers, is a further example of a bolt system. However, a threaded screw is not part of a bolt system nor a bolt system itself because it does not have a bolt. In contrast to a threaded screw, a bolt does not have a head.

The bolt tensioning device can be configured, for example, as torque wrench, electric torque screwdriver, hydraulic torque screwdriver, pneumatic torque screwdriver or in particular hydraulic bolt tensioning device. The bolt tensioning device can generate a pre-tension in the bolt system or the bolt, respectively, in a hydraulic manner. In one form, the bolt tensioning device is operated by the installer or a robot. The bolt systems can be tensioned hydraulically. An exact, repeatable tensioning of the bolt system is made possible with the use of hydraulics. This method makes it possible to tension the bolts with a precision and a force, which cannot be reached with conventional manual methods.

Determining flange parameters at least of the first flange and of the second flange of the flange connection takes place in step a of the method. The flange parameters, which are recorded and analyzed, comprise a number of physical and material-related features, which are specific for the respective application. For example, flange parameters can be a thickness of the flange, an outer diameter of the flange, an inner diameter of the flange, structures connected to the flange, such as, for example, a tower wall, a distance of the flange recesses, a diameter of the flange recesses as well as type and/or material of the used bolt systems.

Exemplary enumerations are not to be considered to be exhaustive in terms of the present disclosure but can be supplemented by a person having ordinary skill in the art.

A bolt system-typical elongation behavior, an axial stiffness C_{bolt} for the bolt and determining an axial stiffness of the flange body of the pre-tensioned flange connection is determined analytically in step b of the method. A compression behavior of a bolt tensioning device is, in one form, likewise determined. Further calculations can advantageously be made with the knowledge of the values for bolt system-typical elongation behaviors, for the axial stiffness C_{bolt} for the bolt and for the axial stiffness of the flange body of the pre-tensioned flange connection and, in one form, the compression behavior of a bolt tensioning device.

The elongation behavior of the bolt system describes how the bolt system, in particular the bolt, lengthens or shortens under load. It is based on the inherent material properties of the bolt and can be determined by classical mechanical tests and analyses, such as, for example, tensile tests. The elongation behavior provides information about how the bolt will react to different loads, in particular with regard to elastic and plastic deformations. If the material properties are known, the elongation behavior can be determined mathematically.

The axial stiffness of the bolt is a measure for a resistance of the bolt against axial forces. The axial stiffness is influenced by the geometry of the bolt, the material and the type of application. The stiffness can be calculated in particular in accordance with VDI 2230 of December 2014.

The axial stiffness of the flange body of the pre-tensioned flange connection is, in one form, determined from the measured process variables during the pre-tensioning of the bolts.

For example, the tensioning of the bolt system or of the bolt, respectively, in one form, the pre-tensioning can have the following sequence: applying a tensile force up to a restoring force or until a restoring pressure, for example of approximately 30 bar to approximately 100 bar, is reached, respectively, applying a tensile force to a bolt of the bolt system until a certain maximum force is reached and determining, in one form, continuously determining during the application of the tensile force, of a distance, which correlates with a bolt elongation, a compression of the bolt tensioning device and/or a flange compression of the flange connection, re-tightening the nut of the bolt system, in one form, with a certain torque, releasing the tensile force to approximately 0 N, and applying the tensile force, which corresponds to the installation pre-tensioning force. It is provided in one form that the preceding steps are repeated once again prior to applying the installation pre-tensioning force.

When the term “approximately” is used as part of the present disclosure in connection with values or value ranges, this is to be understood to be a tolerance range, which the person of skill in the art considers to be customary, in particular a tolerance range of ±20%, ±10%, or ±5%. If different value ranges are specified in the present disclosure, for example, the lower limits and the upper limits of the different value ranges can be combined with one another.

A documentation of the method, in one form, takes place before, during and/or after each step. The mentioned steps for the pre-installation of the bolt system are not limiting. In further forms, further operating sequences can also be possible so as to be nested within each other several times, wherein all steps are, in one form, documented. It is provided in one form that parameters of the tensioning of the screw connection are documented by the computing unit. Parameters can, for example, be a screw identification number, a maximum force, an elongation value, a bolt tensioning device compression, a flange compression, a reached installation pre-tensioning force, results of a distance measurement and/or angle measurement while tensioning the screw connection, name of the installer, a description of the company, flange description, diameter of the screw connection, a tensile force applied by the bolt tensioning device, a hydraulic pressure, a release force, a lot number in particular of all used tools, a lot number or an identifier, respectively, of the screw connection or of the bolt system, respectively, or of the individual parts thereof, respectively, a software version of the computing unit, a date, a time, a description of the performed operation, a qualitative statement about the success of the tensioning of the bolt system, an ambient temperature and/or an angle of rotation of the nut of the screw connection. The documentation of the tensioning of the screw connections can, in one form, take place before, during and/or after the tensioning of the screw connection or of the bolt system, respectively, by the bolt tensioning device.

In terms of the present disclosure, “flange body” is understood to be an integral or assembled part, by which two or more parts can be mechanically connected to one another. The flange body in particular comprises at least the first and the second flange. The flange body is typically circular or ring-shaped and has recesses or openings, which serve the purpose of receiving fastening elements, such as, for example, the bolt systems. It can consist of different materials, including but not limited to metals, alloys, plastics or composite materials. The flange body in particular does not only serve the purpose of the physical connection but, in one form, also provide that a tight seal exists between the connected parts in order to inhibit the ingress of liquids, gases or other unwanted elements. In one form, the flange body can also contribute to evenly distributing the loads or tensions acting on the connection in order to increase the durability and reliability of the entire construction.

In terms of the present disclosure, an installation pre-tensioning force Fₘ is to be understood to be a force on the bolt, which is smaller than or equal to the installation tensioning force F_{target}, which is desired for the finished installation. The installation pre-tensioning force Fₘ for pre-tensioning the bolt system is thus applied by the bolt tensioning device, in particular for determining the reached overall stiffness C_{act}. The installation tensioning force F_{target} is the force, which is applied by the bolt tensioning device when the nut of the bolt system is screw-connected. The installation tensioning force F_{target} is thus that force, with which the bolt system is to ultimately be tensioned. In one form, the installation tensioning force F_{target} is approximately equal to the installation pre-tensioning force Fₘ. In a further form, the installation pre-tensioning force Fₘ is approximately 0.1 to approximately 0.95 the installation tensioning force F_{target}. In another form, the installation pre-tensioning force Fₘ is approximately 0.5 to approximately 0.95 the installation tensioning force F_{target}. In yet another form, the installation pre-tensioning force Fₘ is approximately 0.7 to approximately 0.95 times the installation tensioning force F_{target}. In terms of the present disclosure, a “pre-tensioning” of the bolt system or of the flange connection, respectively, is an applying of the pre-tensioning force to the bolt or the bolt of the flange connection, respectively.

The analytical and/or numerical analysis for specifying the maximally permissible gap dimensions Sₙ is provided in step c of the proposed method, so that a fatigue impairment to the bolt system in consideration of specific boundary conditions does not exceed a defined total impairment.

In terms of the present disclosure, “fatigue impairment” is understood to be a gradual material impairment process, which is caused by repeated load cycles or tension fluctuations, which can typically lie significantly below the maximum strength of the material. These repeated stresses lead to microscopic cracks in the material, which can propagate over time until the structural integrity of the component is negatively impacted and it ultimately fractures. With regard to the flange connections in particular in wind power plants, the fatigue impairment refers in particular to the gradual malfunctioning of the bolt system and other components connected thereto, which is influenced by the constant and dynamic loads, to which the plant is exposed during its operation.

In terms of the present disclosure, “total impairment” is understood to be the cumulative impairment to a material or to a structure, in particular to the flange connection or to the bolt system, respectively, over the entire service life or over a certain time period. This includes the initial micro-malfunctions as well as the resulting macro-malfunctions, which can result from repeated load cycles. In the context of the present disclosure, the total impairment relates in particular to the bolt system and the corresponding components within the flange connection, for example of wind power plants. Compared to the “fatigue impairment,” which describes specifically the gradual impairment process due to repeated load cycles, the total impairment comprises all types of impairments, including but not limited to fatigue, corrosion, mechanical impairment and other environmental influences. It is the goal to reduce the total impairment by the proposed method, wherein a special focus is on the inhibiting of fatigue impairment.

The numerical and/or analytical analysis is advantageous because the size of these gap dimensions is directly related to the durability and safety of the bolt system. When the gap dimensions lie outside of the permissible limits, they could lead to premature fatigue impairments to the bolt system under the enormous loads, to which wind power plants are exposed in particular in turbulent wind conditions.

It is provided by the numerical and/or analytical analysis that the gap dimensions lie within tolerances, which do not affect the structural integrity of the bolt system. It does not only consider the physical dimensions of the bolt system and of the flange connection but also specific boundary conditions, which could be at hand, for example, due to the respective material, the ambient and operating climate or also due to special application requirements. By the exact definition of the maximally permissible gap dimensions, a defined total limit is set, which must not be exceeded in order to provide the improved function and service life of the entire flange connection.

A further advantage of this numerical and/or analytical analysis in step c is that it does not only evaluate the immediate behavior of the bolt systems under different load scenarios but also helps to define preventative measures in order to detect and reduce potential challenges. The result is a robust, secure and efficient flange connection, which was developed specifically for the requirements and challenges of wind power plants.

A numerical analysis, in one form, comprises at least one simulation. The numerical analysis is, in one form, performed by a finite element method FEM. A plurality of gap dimensions are in particular simulated under specified load states over time. An analytical determination is understood to be a calculation with in particular known, measured or numerically determined values, in one form, by at least one mathematical formula.

In terms of the present disclosure, “boundary conditions” refer to certain external factors or scenarios, which must be considered during the evaluation and the design of the flange connections, for example for wind power plants. These are in particular load states, flange parameters and/or pre-tensioning forces.

“Load states” are specific force effects, which act on the flange connection during the operation of the wind power plant. Wind loads play a crucial role, for example in the environment of a wind power plant, because they exert continuous and varying pressure on the structure of the plant. These wind loads are not constant and can vary strongly, depending on weather conditions, geographical location and season. They act on the flange connection for a defined time period and can be of a steady as well as gusty nature. The impacts of these stresses have to be considered when designing, installing and monitoring the flange connection in order to provide a secure connection of the flanges of the wind power plant.

It is provided, in one form, that the specific boundary conditions, in particular load states, are at least partly taken from a Markov matrix P for load states and partial impairments to the flange connection, from which a total impairment value D_{MAR} for each bolt system results, which is smaller than 1.

The complexity of the load states and partial impairments can be displayed with the use of a Markov matrix P. This matrix provides for a systematic and mathematical observation of the variable load states and the impacts thereof on the integrity of the flange connection.

The Markov matrix is a tool from the probability theory, which is used to describe the transition probabilities between different states in a system over time. This matrix is particularly useful when the probability of a state change is only a function of the current state and not of previous states, a concept, which is referred to as Markov property.

In the context of the flange connection, the states of the Markov matrix are defined so that they represent different load states and partial impairments. Each element of the matrix specifies the probability that the flange connection transitions from a certain state, for example a certain load state, to a different state, for example a certain partial impairment. In particular only the load states are gathered from a Markov matrix and not the transition probability relating to the malfunction of the bolt connection. The Markov matrix is, in one form, provided by a flange manufacturer or wind power plant manufacturer. In one form, the load states are measured at already existing flange connections or wind power plants, respectively.

The total impairment value D_{MAR}, which is extracted from the Markov matrix P, provides a quantitative estimate of the impairment caused to the bolt system. A value of D_{MAR}, which is smaller than 1, then suggests that the system is not completely impaired yet and that the flange connection still remains functional in spite of the variable load states and partial impairments.

By applying this method, a precise and adaptive evaluation of the flange connection is made possible, which considers the varying load states and the potential impacts thereof on the service life and stability of the connection. Potential challenges can thus be identified during the installation of the flange connection and proactive measures can be taken in order to provide the durability and safety of the wind power plant. In particular the load states in particular from the Markov matrix can be used for the FEM analysis in order to simulate flange connections with different gap dimensions, installation pre-tensioning forces and/or installation forces.

A numerical analysis is, for example, the performance of a number of, in one form, of a plurality of simulations of a flange connection, in particular FEM analyses, which has the determined parameters of the flange connection, in the case of a plurality of defined different load states and a plurality of different installation pre-tensioning forces Fₘ, which can be applied to the bolt systems, wherein at least one defined gap between the flanges comprising a largest gap dimension Sₙ is in each case simulated during an individual simulation.

A numerical analysis is in particular a performance of a plurality of simulations, which are tailored specifically to the parameters of the flange connection. These simulations model the behavior of the flange connection at defined load states. Different installation pre-tensioning forces Fₘ are, in one form, considered, which are applied to the bolt systems. A plurality of different gaps between the flanges are, in one form, considered or numerically analyzed, respectively, during the numerical analysis. A defined gap, which has the largest gap dimension Sₙ, is, in one form, determined by the numerical analysis. The observation of this largest gap dimension is desired because it represents the most desirable scenarios, under which the flange connection has to work.

A relation of gap dimension to installation pre-tensioning force and/or installation force, which indicates that the flange connection has a sufficient non-positive connection (frictional or force-fit connection) or that the flange connection does not have a sufficient non-positive connection, can advantageously be determined by the numerical analysis. The largest gap dimension Sₙ is the largest simulated gap dimension, which has a sufficient non-positive connection in the case of an installation pre-tensioning force and/or installation force.

In an exemplary form of step c, the specific boundary conditions are initially identified, such as material properties, environmental conditions and specific requirements of the application. The determination of the different load states, which act on the flange connection during operation, such as static and dynamic loads, wind loads in the case of wind power plants and variable load cycles, takes place subsequently.

For example, the Markov matrix is built subsequently. The states, which are to be displayed in the Markov matrix P, are defined in order to represent different load states and partial impairments to the flange connection. Data relating to the transition probabilities between the defined states is collected, for example from experimental measurements or the literature. The load states are measured, for example, at existing flange connections, for example in wind power plants. The matrix P, which includes the transition probabilities between the different load states and partial impairments, is built with this data.

A first calculation for estimating the gap dimensions based on the data from the Markov matrix furthermore takes place in an exemplary manner. For example, the total impairment value DMAR—Impairment Accumulation Ratio—is calculated here, which has to, in one form, be smaller than 1 in order to indicate that the system is not impaired completely.

For example, a numerical model of the flange connection is initially created in the numerical analysis. The parameters for the simulation are specified, including different gap dimensions, load states and installation pre-tensioning forces. The load states from the Markov matrix are integrated into the simulations. The transition probabilities from the Markov matrix are, for example, not included in the simulation. The Markov matrix is primarily used to use stresses and load sequences in the simulation. A plurality of FEM simulations is performed in order to model the behavior of the flange connection under different scenarios. Different gap dimensions are simulated and the resulting tensions and deformations are analyzed under the load states defined by the Markov matrix.

The results of the FEM simulations are, in one form, evaluated, the tension distributions are analyzed and/or critical ranges are identified. The results are compared to the permissible limit values for fatigue impairment and total impairment. The largest gap dimension Sₙ, in the case of which the structural integrity of the flange connection is still provided, is identified.

For example, a high strength steel, which is exposed to different stresses, such as maritime climate and high wind loads, is used in a wind power plant for the bolt systems and the flanges. The minimum service life is, for example, 20 years. States, such as different wind speeds, operating cycles and resting phases, are defined. Transition probabilities are collected and are displayed in the Markov matrix P. Initial calculations for estimating the gap dimensions reveal, for example, 0.2 mm. A 3D model of the flange connection is created and the simulations are specified. Load states according to the Markov matrix, different gap dimensions and pre-tensioning forces, wherein in particular the transition probabilities are ignored, are considered during the simulation. The FEM analysis is performed, and the tension distributions and deformations are analyzed. The largest gap dimension Sₙ is determined, for example 0.25 mm, in the case of which the tensions still lie within the permissible limit values. The results are validated, and the model is adapted if necessary and is documented.

Only a numerical analysis, in one form only an FEM simulation, for specifying the maximally permissible gap dimensions is in one form performed in step c.

It is provided in step d of the proposed method that an analytical determination of an overall stiffness C_{target}, which is to be reached, of the tensioned flange body takes place in consideration of the previously determined maximally permissible gap dimensions Sₙ and the installation pre-tensioning force Fₘ, which is to be reached for the fatigue safety of the connection during the pre-tensioning.

An overall stiffness C, which is determined or which is to be reached, generally refers to the resistance of the flange connection against deformations. A higher stiffness means that the connection is resistant against external forces, which act thereon. The overall stiffness is in particular a measure for the non-positive connection between the first and the second flange. If, for example, no gap is present between the flanges, the overall stiffness is larger than when a gap is present. In terms of the present disclosure, a relation of an overall stiffness, which is determined or which is to be reached, of the flange connection to the installation pre-tensioning force Fₚᵣₑ is generally understood to be a value, which follows from the division C/Fₚᵣₑ.

In terms of the present disclosure, “fatigue safety” is understood to mean that a component, in particular the bolt system and components of the flange connection connected thereto, is able to withstand the repeated load cycles and tension fluctuations over the entire provided service life of the application, without having indications of a gradual material impairment. The fatigue safety thus provides that no unwanted microscopic cracks or material malfunctions are created in spite of the repeated and variable loads, to which a wind power plant is exposed, for example. The specific aim is to provide the structural integrity of the flange connection and/or of the bolt connection over the provided time period and to thus inhibit a premature malfunctioning caused by signs of fatigue.

A maximum gap dimension Sₘₐₓ is in particular determined from the largest gap dimensions Sₙ, in the case of which the simulation does not exceed a defined total impairment for each bolt system. The maximum gap dimension Sₘₐₓ is, in one form, defined from the collection of the measured or simulated gap dimensions as the largest determined gap dimension. This dimension indicates the largest distance between the two flanges in the connection, which is in particular barely still considered to be fatigue-proof. It is determined during the analysis and simulation of the flange connection whether the defined total impairment for each bolt system is not exceeded in the case of the maximum gap dimension Sₘₐₓ.

The setting of this impairment limit and the determination of the corresponding maximum gap dimension provides that the flange connection remains functional during its entire service life as well as has a sufficient safety margin with respect to potential fatigue impairment. The bolt systems are introduced into the flange recesses, which are aligned to one another, of the first flange and of the second flange in step e. and the bolt tensioning device is installed on a bolt in step f.

An installation pre-tensioning force Fₘ is applied to the bolt in step g and a reached overall stiffness C_{act} of the tensioned flanges is determined. For this purpose, a length change is determined in particular by a distance measurement during the tensioning of the flange, which length change can be determined at least from the elongation of the bolt as well as the compression of the flange connection and the bolt tensioning device. Due to the fact that the force expended by the bolt tensioning device is known, the compression of the flange connection can be determined on the basis of the elongation behavior of the bolt determined prior to the process and on the basis of the known compression behavior of the bolt tensioning device. The reached overall stiffness C_{act} is calculated as follows:

$${C}_{act} = ( \frac{Δ l}{{F}_{m}} ) - {C}_{bolt}$$

Δl is hereby the measured length change while applying the installation pre-tensioning force Fₘ exerted by the bolt tensioning device, wherein the compression of the bolt tensioning device has, in one form, already been subtracted. C_{bolt} is furthermore the bolt stiffness, which is, in one form, calculated in accordance with VDI2230 of December 2014.

A method for screw-connecting bolts is known, for example, from the EP 3 566 816 A1, to which reference is made in its entirety, in the case of which a tensioning force is applied to the bolt, until a certain maximum force is reached, and an elongation value is determined, which correlates with a bolt elongation, a bolt tensioning device compression and a flange compression of the flange connection. The method of the EP 3 566 816 A1 can be used with the proposed method.

In step h of the method, the reached overall stiffness C_{act} is compared to the overall stiffness C_{target}, which is to be reached. The comparison provides for a qualitative statement about the fatigue safety of the flange connection, in particular at the position of the bolt tightened right now. The statement can, in one form, be made that the flange connection does not have a sufficient fatigue safety when the reached overall stiffness C_{act} is smaller than the overall stiffness C_{target}, which is to be reached. The statement can, in one form, be made that the flange connection has a sufficient fatigue safety when the reached overall stiffness C_{act} is larger than or equal to the overall stiffness C_{target}, which is to be reached.

It is, in one form, provided that a result of the comparison from step h is output. The result of the comparison from step h is, in one form, transferred to the bolt tensioning device. The bolt tensioning device is, in one form, controlled on the basis of the result of the comparison from step h. The bolt system is, in one form, pre-tensioned once again with the installation pre-tensioning force on the basis of the result of the comparison from step h, in one form, by the bolt tensioning device, in an automated manner, or the bolt system is released. The bolt system is, in one form, pre-tensioned once again with the installation pre-tensioning force on the basis of the result of the comparison from step h, in one form, the bolt tensioning device, in an automated manner, or the bolt system is released or the bolt tensioning device is released from the bolt system.

It is provided according to the present disclosure that the nut of the bolt system is tightened in a step i when the value of the reached overall stiffness C_{act} in relation to the applied installation pre-tensioning force Fₘ is larger than or equal to the overall stiffness C_{target}, which is to be reached, in relation to the applied installation pre-tensioning force Fₘ. When the reached overall stiffness C_{act} in relation to the applied installation pre-tensioning force Fₘ is larger than or equal to the overall stiffness C_{target}, which is to be reached, in relation to the applied installation pre-tensioning force Fₘ, the bolt system is, in one form, fully tightened. In one form, the bolt system is then relaxed in part or completely once again before it is fully tightened, that is, tightened to the installation tensioning force F_{target}.

It is provided in one form that the bolt system is pre-tensioned once again with the installation pre-tensioning force Fₘ after step h when the value of the reached overall stiffness C_{act} in relation to the applied installation pre-tensioning force Fₘ is smaller than the target value of the overall stiffness C_{target}, which is to be reached, in relation to the applied installation pre-tensioning force Fₘ. Concretely, this means: when the determined reached overall stiffness C_{act} in relation to the applied installation pre-tensioning force Fₘ does not reach the specified target value of the overall stiffness C_{target}, which is to be reached, in relation to the applied installation pre-tensioning force Fₘ, the bolt system is pre-tensioned again or is tensioned to the installation tensioning force F_{target}. This pre-tensioning by the installation pre-tensioning force Fₘ has the goal of reaching the required overall stiffness, which is desirable for a secure and stable connection, in one form, by plastic deformation of the flange connection and/or of the bolt system.

The bolt system is, in one form, first at least partly relaxed before the installation tensioning force F_{target} is applied. This can take place in part or also completely. The reached overall stiffness C_{act} is measured continuously during this process. When the reached overall stiffness C_{act} finally reaches or exceeds the overall stiffness C_{target}, which is to be reached by this measure, in relation to the installation pre-tensioning force Fₘ, the flange connection is classified as being safe against fatigue. This process is, in one form, performed approximately one to approximately three times when the desirable fatigue safety is not reached immediately.

It is provided in one form that when the reached overall stiffness C_{act} is not larger than or equal to the overall stiffness C_{target}, which is to be reached, in relation to the applied installation pre-tensioning force Fₘ, the bolt system is then relaxed in part or completely once again and is then tightened to the installation tensioning force F_{target}, wherein the reached overall stiffness C_{act} is measured. If the overall stiffness C_{act}, which is then reached, in relation to the applied installation pre-tensioning force Fₘ is larger than or equal to the overall stiffness C_{target}, which is to be reached, in relation to the applied installation pre-tensioning force Fₘ, the flange connection is, in one form, evaluated as being sufficiently fatigue-proof.

It is provided in one form that the bolt system is released after step h when the value of the reached overall stiffness C_{act} in relation to the applied installation pre-tensioning force Fₘ is smaller than the target value of the numerically and/or analytically determined overall stiffness C_{target}, which is to be reached, in relation to the applied installation pre-tensioning force Fₘ. It is provided in one form that at least one sheet is inserted between the first flange and the second flange in the region of the bolt system after releasing the bolt system. At least the steps g and h, during which the bolt system is tensioned in a controlled manner, can then be performed once again subsequently. If the measure was successful, the nut of the bolt system is, in one form, tightened in particular in a defined manner.

When the reached overall stiffness C_{act} does not reach the overall stiffness C_{target}, which is to be reached and which was either determined numerically and/or analytically, in relation to the applied installation pre-tensioning force Fₘ, this can lead to unwanted vibrations, loosening or even to the impairment of the connection. In cases like this, one form of the method provides for releasing the bolt system. This mainly serves the purpose of providing for a revision or adaptation of the connection. The so-called “shimming” comes into play in this context, which represents a known method for adapting flange connections in the prior art. In particular, special sheets or washers are used, which are inserted between the flanges in order to correct the distances and to thus provide a firm and stable fit or non-positive connection, respectively, of the flanges one on top of the other.

It can be provided in a further form that these sheets are configured specifically for the use in flange connections. These can be sheets with a u-shaped recess, which fit around the bolt and thus provide a particularly precise fit and provide for a quick insertion, without the bolt connection having to be released completely. The insertion of these sheets or “shims” thereby takes place selectively in the region of the bolt in order to, in one form, increase the non-positive connection.

It is provided in one form that the steps g and h are repeated. The steps g and h are, in one form, repeated after at least one sheet was introduced between the flanges. An installation pre-tensioning force Fₘ is in particular applied to the bolt, in turn, and a reached overall stiffness C_{act} of the tensioned flange is determined and is then compared to the overall stiff C_{target}, which is to be reached. In one form, an installation pre-tensioning force Fₘ is used, which deviates from the previous installation pre-tensioning force and which is in particular larger or smaller.

It is provided in one form that all bolt systems of the flange connection are tightened to a fraction of the provided installation pre-tensioning force F_{target}, before the method steps h to i are performed on the first bolt system. They are tightened in particular with a tensioning force of approximately 0.01*F_{target} to approximately 0.95*F_{target}, and in another form approximately 0.01*F_{target} to approximately 0.3*F_{target}.

It is provided in one form that the method steps g to h are in each case performed on the bolt system, in the case of which the gap between the first flange and the second flange is largest. The tensioning order of the bolts is in particular specified hereby. An exemplary form can be described as follows: different gap dimensions often appear between the flanges, which are to be connected, during the installation of a wind power plant, in particular during the connection of large flanges, which connect for example the tower segments to one another. It is provided, for example, that the bolt, which is located at the point with the largest gap dimension between the first and the second flange, is identified first. This specific bolt is used as reference point for the following installation steps. The method steps g to h are performed specifically at this bolt system in order to provide the desired tension and alignment of the flanges. The selection of this specific bolt system as starting point provides that the tension applied to the flanges and the torque are applied in a sequence, which provides for an even and secure tightening of all bolts. An even load distribution and a secure fit of the entire flange connection can be provided by starting at the point with the largest gap dimension and by continuing to systematically work in a specified order. In practice, this could mean that the installer or a robot identifies that region first, in which the largest gap dimension is present, during the installation of the flanges of a wind power plant. The first bolt is tightened there, wherein the method steps g to h are performed. The remaining bolts are subsequently tightened in a specified order or that bolt system, in the case of which the largest gap dimension is now present, is identified, in turn, whereby an alignment of the flanges or desired closing of the gaps, respectively, is provided.

It is provided in an exemplary form that a flange connection is installed and the preparatory steps are performed, in that the relevant parameters and stiffnesses are calculated. After installing the bolt tensioning device, a pre-tensioning force is applied to the bolt and the overall stiffness is measured. It is determined that this overall stiffness is smaller than the pre-calculated value. Instead of tightening the nut, the bolt system is released. A sheet is placed between the flanges and the pre-tensioning and measuring steps are repeated. The desired stiffness is reached this time and the nut of the bolt system is tightened with the provided installation tensioning force.

The bolt tensioning device is installed in a further exemplary configuration. The pre-tensioning force is subsequently applied to the bolt with the help of a bolt tensioning device and the overall stiffness in relation to the pre-tensioning force of the flange connection is detected with the help of sensors. The overall stiffness lies below the target value, for example. The method for the renewed pre-tensioning of the bolt system is thus started in the hope of reaching the target value. The process is repeated and the overall stiffness is checked once again. For example, the overall stiffness remains below the target value in spite of the renewed tensioning of the bolt system. In response, the bolt system is released. A sheet is positioned between the two flanges in the region of the bolt system. After the sheet was inserted, the steps of applying the pre-tensioning force and comparing the stiffness are repeated. The desired stiffness is finally reached by this additional sheet and the installation is continued in that the nut of the bolt system is tightened with the specified installation tensioning force. If the target value is still not reached, the above-mentioned steps are, in one form, repeated with a thicker sheet or a plurality of sheets.

A use of a bolt tensioning device comprising a housing, a tensioning unit, a distance measuring device, a tensile force determination and a computing unit is furthermore proposed, wherein a reached overall stiffness C_{act} can be measured by the distance measuring device, wherein a numerically and/or analytically determined overall stiffness C_{target}, which is to be reached, can be stored by the computing unit, for carrying out an above-mentioned method.

The bolt tensioning device has a housing, in which a tensioning unit for applying the desirable pre-tensioning force to the bolt as well as a precise distance measuring device are accommodated. The reached overall stiffness C_{act} of the flange can be determined during the tensioning process by the distance measuring device. An integrated computing unit, which is part of this bolt tensioning device, in one form, allows storing an analytically determined overall stiffness C_{target}, which is to be reached. This value, in one form, serves as reference, to which the actually reached stiffness during the installation process is compared. The computing unit can be installed in the housing or can be connected to the remaining components, in particular the distance measuring device, spaced apart from said housing in a wired manner or via radio connection. It is, in one form, provided that the computing unit is able to store a series of reference values. This offers the advantage that different target values can be stored for the overall stiffness, depending on flange type, material or application. A further aspect, which can be configured by computing unit, is the possibility of calculating a reached overall stiffness C_{act} and/or a flange compression Δf from the measured values.

A computer program product is furthermore proposed, comprising commands, which have the effect that a bolt tensioning device carries out the method according to the present disclosure, with a data set comprising at least one reference value series, which is determined from the steps of a) determining flange parameters at least of the first flange and of the second flange of the flange connection, b) analytically determining a bolt system-typical elongation behavior, determining an axial stiffness C_{bolt} for the bolt and determining an axial stiffness of the flange body of the pre-tensioned flange connection, c) analytical and/or numerical analysis for specifying the maximally permissible gap dimensions Sₙ, so that a fatigue impairment to the bolt system in consideration of a specific boundary condition does not exceed a defined total impairment, and d) analytically determining an overall stiffness C_{target}, which is to be reached, of the tensioned flange body in consideration of the previously determined maximally permissible gap dimensions Sₙ and of the installation pre-tensioning force Fₘ, which must be reached for a fatigue safety of the connection during the pre-tensioning.

The reference value series, which in each case reflects a target value of a relation of a numerically and/or analytically determined overall stiffness C_{target}, which is to be reached, to an installation pre-tensioning force Fₘ, wherein a reached overall stiffness C_{act} in relation to an applied installation pre-tensioning force Fₘ on a bolt system can be compared to the target value, so that a qualitative statement about the flange connection can be output at a position of a bolt system by the computer program product. The computer program product, in one form, carries out the above-mentioned method. The proposed computer program product is advantageously able to evaluate the integrity and suitability of flange connections on the basis of reference values. The results of the evaluation can furthermore be used during the installation of flange connections.

The computer program product includes at least one data set, which comprises at least one reference value series. This set in each case represents a target value, which represents the relation of a numerically and/or analytically determined overall stiffness C_{target}, which is to be reached, to an installation pre-tensioning force Fₘ. In the practical application, this computer program product provides for the direct comparison of a measured, reached overall stiffness C_{act} of a given bolt system in relation to the actually applied installation pre-tensioning force Fₘ to the corresponding target value. Based on this comparison, the program can generate a qualitative statement with regard to the integrity and quality of the flange connection at a certain position of the bolt system.

It is provided according to the present disclosure that, depending on the qualitative statement, the computer program product prompts a nut of the bolt system to be tightened or the bolt system to be released. The computer program product, in one form, offers the possibility of initiating automated actions, based on the qualitative statements made. This means that should the computer program product identify a discrepancy or a potential challenge, it can prompt, for example, a nut of the bolt system to be tightened or released. In cases, in which the flange connection is evaluated to be unsuitable or potentially unsafe, the program can also give the instruction that the entire bolt system is released in order to introduce, for example, at least one sheet between the flanges.

The results of the evaluation are furthermore advantageously transferred by the computer program product to a robot, which installs the flange, depending on the results. For example, the robot releases the currently tensioned bolt system again in order to insert sheets, when the fatigue safety is not provided. For example, the robot tightens the bolt system to an installation tensioning force F_{target}, when the fatigue safety is provided.

In one form, an output unit is provided, which instructs an installer as to what needs to be done with the current bolt system, for example, release or tighten bolt system.

A use of an above-mentioned computer program product in an above-mentioned method is furthermore proposed.

A storage medium on which the computer program according to the present disclosure is stored, comprising a data set comprising at least one reference value series is furthermore proposed, which each reflects a target value of a relation of a numerically and/or analytically overall stiffness C_{target}, which is to be reached, to an installation pre-tensioning force Fₘ, wherein the reference value series is determined from the steps of a) determining flange parameters at least of the first flange and of the second flange of the flange connection, b) analytically determining a bolt system-typical elongation behavior, determining an axial stiffness (Cbolt) for the bolt and determining an axial stiffness of the flange body of the pre-tensioned flange connection, c) analytical and/or numerical analysis for specifying the maximally permissible gap dimensions (Sn), so that a fatigue impairment to the bolt system in consideration of a specific boundary condition does not exceed a defined total impairment, and d) analytically determining an overall stiffness (Ctarget), which is to be reached, of the tensioned flange body in consideration of the previously determined maximally permissible gap dimensions (Sn) and of the installation pre-tensioning force (Fm), which must be reached for a fatigue safety of the connection during the pre-tensioning.

The storage medium, which comprises a data set with at least one reference value series, advantageously displays a technical effect with regard to the improvement and efficiency of flange connections. The storage medium provides the possibility of efficiently storing and retrieving desirable data, which represents the relation of a numerically and/or analytically determined target value of an overall stiffness C_{target}, which is to be reached, to an installation pre-tensioning force Fₘ. This data is the result of technical calculations and its quick availability is important in order to secure and efficiently construct and operate mechanical systems, such as the bolt tensioning device or a robot therewith.

The technical effect of the storage medium and the data set located thereon lies in particular in its ability of accelerating the processes of the automated decision-making, adaptation and implementation of flange connections. By holding these specific data relations available, engineers and experts can quickly determine and apply the desirable values for the installation pre-tensioning force with regard to the desired overall stiffness. This reduces the need of repeated manual calculations, reduces errors and increases the reliability of the overall system.

In combination with the corresponding computer program product, the storage medium additionally provides for the automation of certain processes, which would otherwise need to be carried out manually and in a time-consuming manner. This leads to a further technical effect in the form of increased efficiency and accuracy in the implementation of flange connections.

The present data set, which comprises a reference value series, which in each case represents a relation of a numerically and/or analytically determined target value of an overall stiffness C_{target}, which is to be reached, to an installation pre-tensioning force Fₘ, has a significant technical character. In this context, the data set is not only considered to be a collection of information or pure data but, on the contrary, to be an desirable tool, which contributes to solving a specific technical problem.

The creation of this data set is based on extensive technical considerations and calculations. It serves the purpose of better understanding and controlling the interaction and the cooperation between different technical elements, here in particular the overall stiffness of a system and the installation pre-tensioning force required for this purpose. With the knowledge of the relations included in the data set, a precise, improved and repeatable application of installation pre-tensioning forces can be carried out in order to reach a desired overall stiffness. This has direct impacts on the mechanical properties of the system and can lead to an improved performance, safety and service life of the overall system.

When it is stored in a suitable storage medium and when it is interpreted by a corresponding computer program product, the data set furthermore offers the possibility for automating processes, which are desirable for installing, adjusting and improving flange connections. This does not only provide for a faster and more exact implementation but also inhibits human errors and reduces the need for manual interventions, which, in turn, leads to an increase of the overall productivity and efficiency.

In summary, the storage medium and the data set do not only serve as passive data storage but they also support the technical improvement and efficiency increase of flange connection systems. A clear and substantial technical effect is reached hereby.

The introduced method for installing flange connections provides a precise, improved and repeatable installation of flange connections in an advantageous manner by a comprehensive analytical and/or numerical analysis of the relevant flange and bolt parameters. The integrity and service life of the flange connection can be improved significantly by the analytical and/or numerical determining of a permissible overall stiffness as well as of further desirable parameters. The systematic determination of the maximally permissible gap dimensions during the installation in consideration of specific boundary conditions additionally permits a high fatigue safety of the bolt system and of the flange connection in an advantageous manner. With the implementation of this method, the use of the computer program product benefits from an automation and standardization of the process, whereby human errors are reduced and the overall efficiency is increased. The storage medium, which includes the reference value series data, advantageously serves as tool, which provides for a consistent and precise application of the method, whereby the quality and reliability of the tensioned flange connections ultimately increases.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for installing flange connection, wherein the flange connection has at least one first flange, a second flange and a number of bolt systems, wherein the at least one first flange has a plurality of first flange recesses and the second flange has a plurality of second flange recesses, wherein the plurality of first flange recesses are aligned to the plurality of second flange recesses, wherein the number of bolt systems each have at least one bolt, a nut and an abutment, the method comprising:
a. determining flange parameters of the at least one first flange and the second flange;
b. analytically determining a bolt system-typical elongation behavior, determining an axial stiffness for the at least one bolt and determining an axial stiffness of a flange body formed by applying an installation pre-tensioning force to the at least one bolt to mechanically connect the at least one first flange and the second flange to each other;
c. analytically and/or numerically analyzing for maximally permissible gap dimensions, so that a fatigue impairment to the number of bolt systems in consideration of a specific boundary condition does not exceed a defined total impairment;
d. analytically determining an overall stiffness of the flange body considering the determined maximally permissible gap dimensions and the installation pre-tensioning force;
e. introducing at least one bolt system of the number of bolt systems into a corresponding first flange recess of the plurality of first flange recesses and a corresponding second flange recess of the plurality of second flange recesses that are aligned with each other;
f. determining a reached overall stiffness of the flange body;
g. comparing the reached overall stiffness to the determined overall stiffness; and
h. tightening the nut of the at least one bolt system with an installation tensioning force when the reached overall stiffness is larger than or equal to the overall stiffness.

2. The method according to claim 1, wherein the at least one bolt system is pre-tensioned once again with the installation pre-tensioning force when the reached overall stiffness is smaller than the overall stiffness.

3. The method according to claim 1, wherein the at least one bolt system is released when the reached overall stiffness is smaller than the determined overall stiffness.

4. The method according to claim 3, wherein at least one sheet is inserted between the at least one first flange and the second flange in a region of the at least one bolt system after releasing the at least one bolt system.

5. The method according to claim 4, further comprising:
applying another installation pre-tensioning force to the at least one bolt after the at least one sheet is inserted between the at least one first flange and the second flange in the region of the at least one bolt system;
determining another reached overall stiffness of the flange body; and
comparing the another reached overall stiffness to the overall stiffness.

6. The method according to claim 1, wherein the installation pre-tensioning force is applied to the at least one bolt in an area of the flange body where a gap between the at least one first flange and the second flange is largest.

7. The method according to claim 1, wherein the specific boundary condition is at least partly taken from a Markov matrix for load states and partial impairments to the flange connection, from which a total impairment value for each bolt system results, which is smaller than 1.

8. A bolt tensioning device comprising a housing, a tensioning unit, a distance measuring device, a tensile force determination and a computing unit, wherein the reached overall stiffness is measured by the bolt tensioning device, wherein the analytically determined overall stiffness is stored by means of the computing unit, for carrying out a method according claim 1.

9. A computer program product, comprising commands, which have an effect that the bolt tensioning device of claim 8 carries out the method according to claim 1, with a data set comprising at least one reference value series,
wherein the at least one reference value series in each case reflects a target value of a relation of the analytically determined overall stiffness to the installation pre-tensioning force, wherein the reached overall stiffness in relation to the installation pre-tensioning force on the at least one bolt system is compared to the target value, so that a qualitative statement about the flange connection is output at a position of the at least one bolt system by the computer program product, wherein the computer program product prompts the nut of the at least one bolt system to be tightened or the at least one bolt system to be released, depending on the qualitative statement.

10. A storage medium on which the computer program product according to claim 9 is stored, comprising the data set comprising the at least one reference value series.
